(19) United States
(12) Patent Application Publication
(10) Pub. No.: US 2026/0217055 A1
(43) Pub. Date: Jul. 30, 2026

(54) Poseable Modular Armature System for Sculpting

(71) Applicants: Cynthia Anne Stevens, Centreville, VA (US); Nicholas Alexander Testa, Saint Petersburg, FL (US)

(72) Inventors: Cynthia Anne Stevens, Centreville, VA (US); Nicholas Alexander Testa, Saint Petersburg, FL (US)

(21) Appl. No.: 19/460,289

(22) Filed: Jan. 26, 2026

Related U.S. Application Data
(60) Provisional application No. 63/750,267, filed on Jan. 27, 2025.

(51) Int. Cl. B44C 3/06; B44B 1/06

(52) U.S. Cl. CPC B44C 3/06; B44B 1/06

(57) ABSTRACT

A modular, poseable armature system for sculpting includes interconnectable body, joint, and limb components that form an internal support structure. The components are removably connectable to permit repeated adjustment of pose and configuration during sculpting. An optional support stand may be used to stabilize the armature while sculpting materials are applied.

### TECHNICAL FIELD

The present disclosure relates to sculpting aids and armature systems, and more particularly to a modular, poseable armature system configured to support sculpting materials while allowing adjustable posing and reconfiguration.

### BACKGROUND

Sculptors often rely on fixed or improvised internal supports when creating figurative or animal sculptures. Traditional armatures may require custom fabrication, welding, or irreversible assembly, limiting flexibility and accessibility.

Accordingly, there exists a need for an adaptable armature system that enables users to quickly establish proportion, pose, and balance while remaining reconfigurable throughout the sculpting process.

### SUMMARY

Disclosed herein is a modular, poseable armature system comprising a plurality of interconnectable structural components configured to form a three-dimensional internal support structure.

The system includes body elements, joint elements, and limb elements that are removably connectable to permit repeated assembly, disassembly, and repositioning. The armature system is configured to support sculpting materials and allow a user to adjust pose and orientation during sculpting.

### BRIEF DESCRIPTION OF THE DRAWINGS

FIG. 1 illustrates an assembled pose of the modular armature system.

FIG. 2 illustrates key components of the modular armature system.

FIG. 3 illustrates multiple assembled views of the modular armature system.

### DETAILED DESCRIPTION

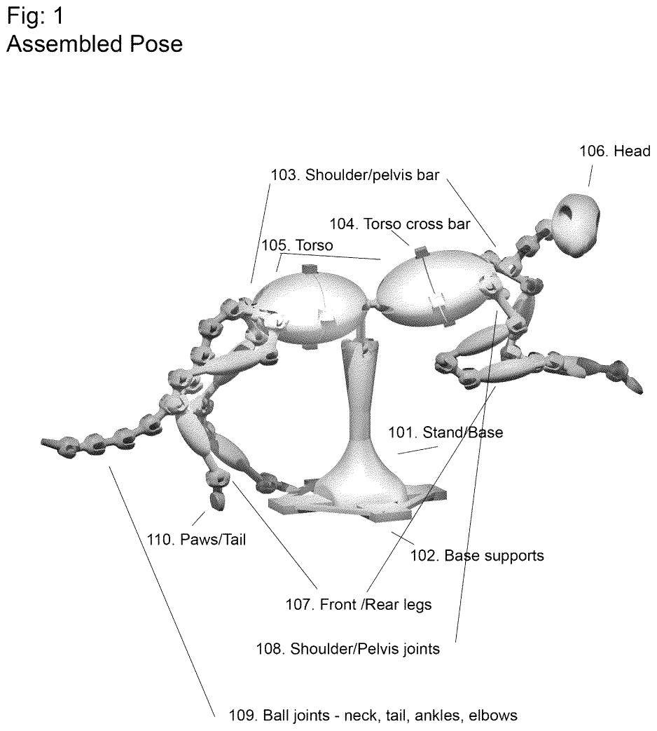

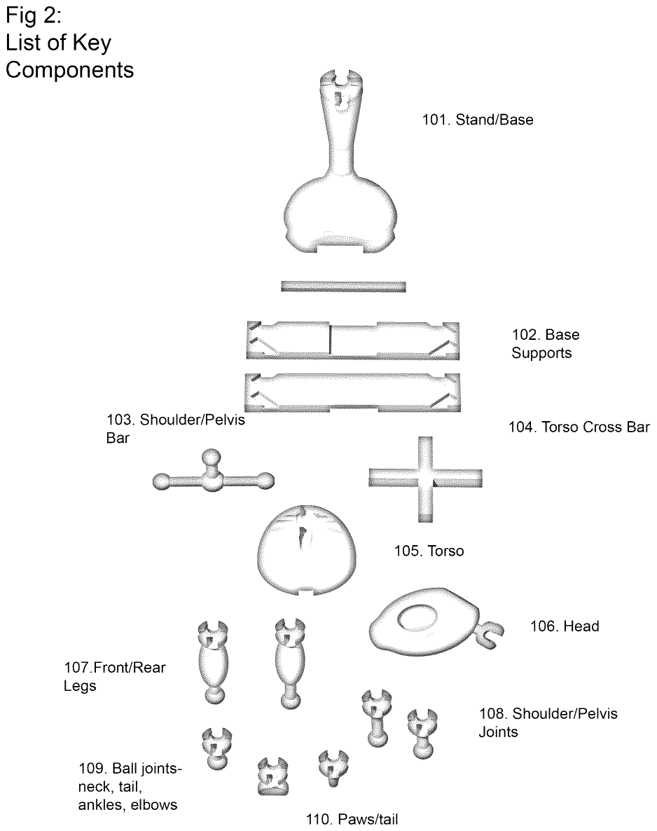

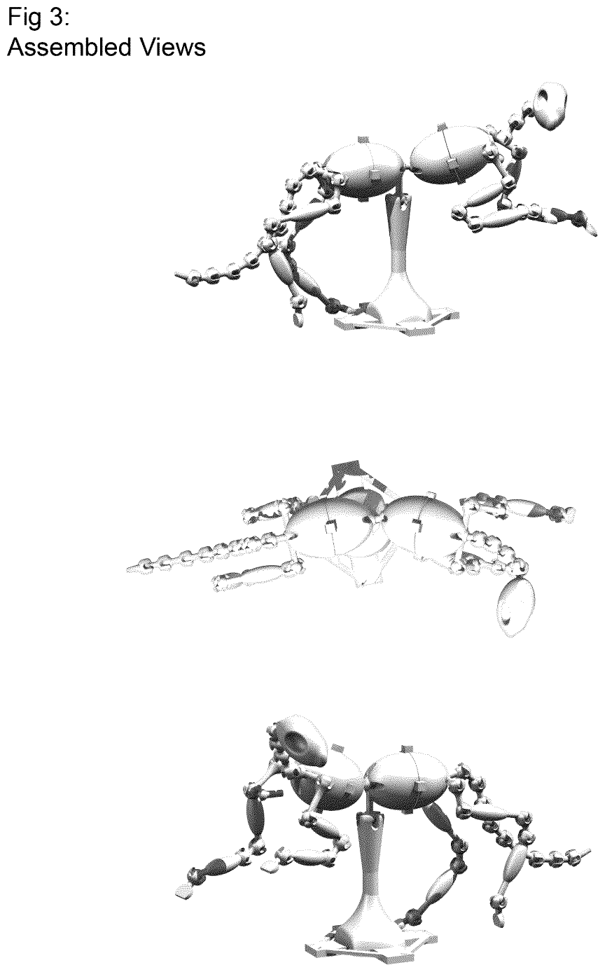

Referring to FIGS. 1-3, the modular armature system includes a plurality of body components (101), joint components (102), and limb components (103).

The body components may define torso or core structures. The joint components are configured to permit rotational movement between adjacent components. The limb components extend outward to support sculpted extremities.

The components may be removably connected using mechanical interfaces such as friction-fit couplings, pins, sockets, or other detachable engagement structures.

In certain embodiments, a support stand (110) may be provided to stabilize the armature during sculpting. The support stand is optional.

The system may be scaled or reconfigured to represent different figures or proportions and may be used with a variety of sculpting materials.

1. A modular, poseable armature system for sculpting, comprising:
a plurality of body components configured to form a central support structure;
a plurality of joint components operably connectable to the body components; and
a plurality of limb components removably connectable to the joint components,
wherein the body components, joint components, and limb components are configured to be repeatedly assembled, disassembled, and repositioned to define multiple poses while supporting sculpting material applied thereto.

2. The armature system of claim 1, wherein at least one joint component permits rotational movement between adjacent components.

3. The armature system of claim 1, wherein the limb components comprise elongated segments configured to support sculpted extremities.

4. The armature system of claim 1, wherein the components are removably connected by one or more detachable mechanical engagement structures.

5. The armature system of claim 4, wherein the detachable mechanical engagement structures include friction-fit couplings, pins, sockets, ball-and-socket joints, or combinations thereof.

6. The armature system of claim 1, wherein the body components define a torso or core structure of a figure.

7. The armature system of claim 1, wherein the system is scalable to represent figures of different sizes or proportions.

8. The armature system of claim 1, wherein the system is reconfigurable to represent animal figures, figurative forms, or abstract forms.

9. The armature system of claim 1, further comprising a support stand configured to temporarily stabilize the armature system during sculpting, wherein the support stand is removable.

10. The armature system of claim 1, wherein the armature system is configured to support sculpting materials selected from clay, epoxy, cementitious material, polymer-based material, or combinations thereof.

11. The armature system of claim 1, wherein the joint components are positioned at locations corresponding to anatomical articulation points.

12. The armature system of claim 1, wherein the limb components are interchangeable to permit modification of pose or proportion.

13. The armature system of claim 1, wherein the armature system is configured to maintain structural stability while allowing repeated adjustment during a sculpting process.

14. A method of sculpting using a modular armature system, comprising:
assembling a plurality of body components, joint components, and limb components to form a poseable armature structure;
adjusting the position of at least one joint component to define a desired pose;
applying sculpting material to the assembled armature structure; and
repositioning at least one component during the sculpting process to modify the pose.

15. The method of claim 14, further comprising supporting the armature structure with a removable support stand during at least a portion of the sculpting process.

16. The method of claim 14, wherein the armature structure is partially disassembled and reassembled during sculpting.

17. The armature system of claim 1, wherein the components are configured to be manufactured by additive manufacturing, subtractive manufacturing, molding, or combinations thereof.

18. The armature system of claim 1, wherein the system permits reuse of the components across multiple sculpting projects.

19. The armature system of claim 1, wherein the armature system provides internal support while preserving access to external surfaces for sculpting.

20. The armature system of claim 1, wherein the armature system is configured to be used by artists, students, or hobbyists.
